(19) United States
(12) Patent Application Publication
(10) Pub. No.: US 2007/0158878 A1
(43) Pub. Date: Jul. 12, 2007

(54) Nonwoven and Method for Producing Fiberglass-Reinfroced or Carbon Fiber-Reinforced Synthetic Materials

(75) Inventor: Keld Lauridsen, Aelborg (DK)

Correspondence Address: CROWELL & MORING LLP;INTELLECTUAL PROPERTY GROUP, P.O. BOX 14300, WASHINGTON, DC, 20044-4300, US

(73) Assignee: FIBERTEX A/S, Aealborg Ost (DK)

(21) Appl. No.: 11/686,074

(22) Filed: Mar. 14, 2007

Related U.S. Application Data
(62) Division of application No. 10/498,306, filed on Feb. 8, 2005.

(30) Foreign Application Priority Data
Dec. 12, 2001 (DE) 10160956.6

(51) Int. Cl. B29C 70/00

(52) U.S. Cl. 264/511; 264/310

(57) ABSTRACT

A mat is used in a method for the manufacture of glass fiber reinforced plastics or carbon fiber reinforced plastics as a layer for the absorption of excess resin expelled during the manufacturing process. The mat consists of thermally bonded plastic fibers, with at least one side of the mat having a solidified surface with a smaller pore size. Various methods are described for the manufacture of glass fiber reinforced plastics or carbon fiber reinforced plastics.

This application is a divisional of U.S. Patent application Ser. No. 10/498,306, the entire disclosure of which is incorporated herein by reference and which entered into the U.S. national phase on Feb. 8, 2005, based on international PCT application serial no. PCT/EP02/13379, filed Nov. 27, 2002, which, in turn, claims the priority of prior German application DE 101 60 956.6, filed Dec. 12, 2001.

### BACKGROUND AND SUMMARY OF THE INVENTION

The invention relates to a mat for use in a method for the manufacture of glass fiber reinforced plastics or carbon fiber reinforced plastics and to methods for the manufacture of glass fiber reinforced plastics or carbon fiber reinforced plastics using this new mat.

Various methods of manufacture are known for glass fiber reinforced plastics or carbon fiber reinforced plastics. In addition to manual lamination in which unheated open molds, for example wooden molds, are used as the mold, vacuum processes or also centrifugal processes have gained acceptance.

A centrifugal method in accordance with the prior art is explained schematically in FIG. 1. Resin-impregnated laminate 12, which is surrounded by a peel-ply 14 which, as such, is permeable to gas and liquid, is there placed onto a drum 10 rotating in the direction of the arrow a. This first peel-ply 14 is surrounded by a second peel-ply 16 which consists of a polyamide fabric. When the drum 10 is spun in the direction of the arrow a, excess resin is expelled from the resin-impregnated laminate coating 12 and passes through the first peel-ply to penetrate into the second peel-ply 16. Due to the fabric structure of this fabric layer, consisting for example of polyamide, resin is expelled during the spinning and contaminates the vicinity of the centrifuge apparatus. After the hardening of the resin, it is usually very difficult to separate the peel-ply, which is in another respect rigid and less flexible, from the peel-ply 14 on the drum 10.

In FIG. 3, another manufacturing process for a glass fiber reinforced plastic or a carbon fiber reinforced plastic is shown schematically. A mold 102 is placed on a table 100 here and resin-impregnated laminate 104 has been layered onto or into it. A peel-ply 106 has been laid around the resin-impregnated laminate 104. The peel-ply 106 is surrounded by a permeable separating foil 108. This is in turn surrounded by means of an absorbing layer 110. The absorbing layer 110 is in turn enveloped by means of a gas-tight foil 112 which is sealed to the side via seals 114. Vacuum suction devices 116 are provided inside the gas-tight foil 112 and the vacuum can be applied via these. This vacuum is distributed uniformly through the absorbing layer 110 such that excess resin from the laminate 104 is transported into the absorbing layer 110 via the air-permeable and liquid-permeable peel-ply 106 and via the permeable separating foil 108. After hardening the glass fiber reinforced plastic or carbon fiber reinforced plastic, the individual foils can be separated from the laminate 104 comparatively easily in the present method, in particular due to the permeable separating foil 108. The assembly present here for the carrying out of the method is, however, comparatively complex and expensive since a series of different layers have to be applied to the laminate 104.

It is an object of the invention to provide a new mat for use in a method for the manufacture of glass fiber reinforced plastics or carbon fiber reinforced plastics with which these methods can be simplified and made cheaper.

This object is solved in accordance with the invention by a mat for use in a method for the manufacture of glass fiber reinforced plastics or carbon fiber reinforced plastics as claimed. A mat is provided here as a layer for the absorption of excess resin expelled during the manufacturing process which consists of thermally bonded plastic fibers, with at least one side of the mat having a solidified surface with a smaller pore size in comparison to the remaining pore size of the mat. This mat has a series of advantages. It can be used either in a centrifugal method or in a vacuum method for the manufacture of glass fiber reinforced plastics or carbon fiber reinforced plastics. It has been found that the mats in accordance with the invention can store the discharged resin ideally when used in the centrifugal method. After hardening the resin, they can be easily separated from the peel-ply of the drum due to their solidified surface with a small pore size. Even with the absorbed and hardened resin, the mat in accordance with the invention is so flexible that it can be rolled up and so handled easily.

When used in the vacuum method, the mat can replace two layers, namely the permeable separating foil and the absorbing layer arranged above this. The permeable separating film, which is to be provided separately, can be replaced due to the solidified surface properties of smaller pore sizes. This surface namely makes it possible to peel of the mat in a simple manner from the first peel-ply which is arranged directly over the resin-impregnated laminate.

Particularly advantageous aspects of the mat in accordance with the invention are also apparent.

Accordingly, the mat can have a basis weight from 50 g/m² up to 1000 g/m². A mat having a basis weight from 100 g/m² up to 600 g/m² is particularly preferred. It furthermore has a preferable thickness from 0.3 mm up to 12 mm.

Finally, the mat in accordance with the invention consists of polypropylene, polyester and/or polyamide fibers or of mixtures of these materials.

If the fibers forming the mat have been manufactured in a melt-blown method, they advantageously have 0.01 dtex up to 0.5 dtex (microfibers). If they are manufactured in a different method, they preferably have 0.8 dtex up to 20 dtex.

The mats can consist of fine fibers or the mats can consist either of thick fibers or of a mixture of thick and fine fibers. The fine fibers permit the manufacture of mats having a fine pore size, whereas the thick fibers serve for mats with a good absorption property. These properties can advantageously be combined in mat production, for instance for the manufacture of multi-ply mats, for example, with the individual layers consisting of fibers of different thicknesses.

The invention further relates to a centrifugal method and to a vacuum method.

Details and advantages of the invention will be explained in more detail with reference to two embodiments shown in the drawing.

### BRIEF DESCRIPTION OF THE DRAWINGS

The drawings provide illustrations briefly described below.

FIG. 1 is a schematic representation of a centrifugal method in accordance with the prior art;

FIG. 2 is a schematic representation of a centrifugal method to illustrate a first embodiment of the present invention;

FIG. 3 is a schematic representation of a vacuum method in accordance with the prior art; and

FIG. 4 is a schematic representation of a vacuum method in accordance with a further embodiment of the present invention in accordance with the invention.

### DETAILED DESCRIPTION OF THE INVENTION

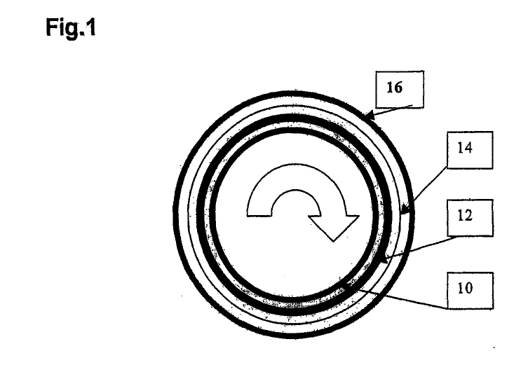

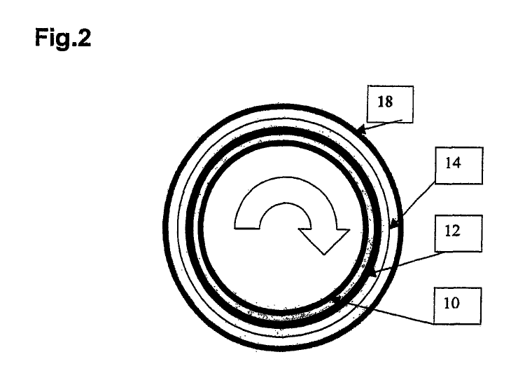

A centrifugal process is shown schematically in FIG. 2 which substantially corresponds to that already described in accordance with FIG. 1. Here, however, a layer consisting of a mat 18 is provided instead of the outer layer of polyamide fabric 16 as is used in accordance with the prior art in accordance with FIG. 1. The layer 18 consists of a mat which has been manufactured from thermally bonded plastic fibers, with at least one side of the mat having a solidified surface with a pore size which is smaller than the pore size of the remaining mat. This solidified surface permits a particularly favorable interface property with respect to the first peel-ply 14 which, as such, is liquid permeable and gas permeable. Due to the correspondingly set pore size, the resin is thus here held back in the laminate 12, on the one hand, and some is absorbed into the mat and stored there, on the other hand. On the other hand, due to the solidified surface with a small pore size, a removal of the mat 18 from the peel-ply 14 is possible without problem. Due to the properties of the mat, it can also be rolled up with the resin absorbed and stored in the mat and so can be easily disposed of. It is particularly advantageous that no unwanted resin edges form on the surface of the hardened glass fiber reinforced plastic 12 or carbon fiber reinforced plastic 12. The circular drum 10 shown in the representation 2 can also be another mold of any desired shape.

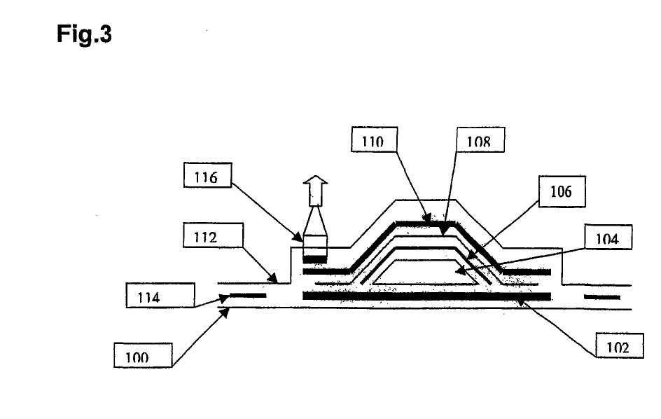

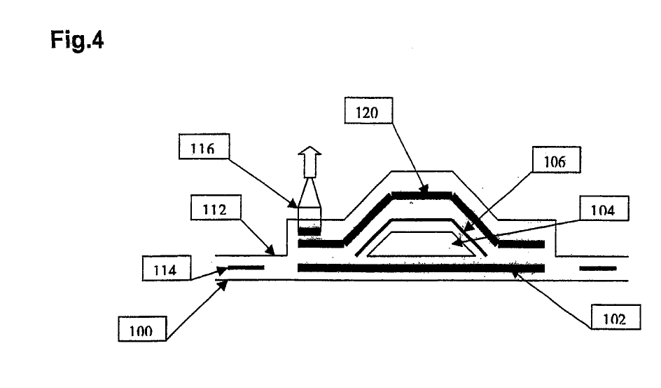

A vacuum method is shown schematically in FIG. 4 using the mat in accordance with the invention. This substantially corresponds to that in accordance with FIG. 3, which was previously described as the prior art. However, the permeable separating foil 108 and the absorbing layer 110 are here replaced by the mat 120. On the one hand, the permeable separating foil 108 in accordance with FIG. 3 and the absorbing layer 110 in accordance with FIG. 3 are here replaced by a single layer, namely the mat 120. The handling is hereby substantially simplified, on the one hand. The new method is also more cost-favorable than the multi-ply method in accordance with the prior art. Due to the pore structure of the mat, a very good distribution of the vacuum over the whole laminate structure 104 is ensured, on the one hand. The excess resin is absorbed over an equal area, on the other hand. A smooth and regular surface without corners and edges or faults in the glass fiber reinforced plastic component or carbon fiber reinforced plastic component to be shaped is hereby ensured.

The mat 120 or 18 is mainly manufactured from thermoplastic fibers made of polypropylene, polyester, polyamide and/or copolymers of these materials. Staple fibers, endless fibers, bi-component fibers or mixtures thereof are used. The manufacturing method of the mat as such is known and will therefore not be explained again in detail here. A customary mat, a needle mat, a spun-bonded mat, a melt-blown mat, an air-laid mat can be used alone or in combination as the mat 120 or 18. It is important that one side of the mat has a solidified surface with a comparatively smaller pore size. This solidification can be created, for example, by heat treatment of the surface or also by other method steps.

With the mat 120 or 18 in accordance with the invention, a very good flexibility results in the absorption capacity for the excess resin by adaptation of the basis weight of the mat 120 or 18 or by overlapping a plurality of layers of the mat. More absorption volume to accept the excess resin can thus be made available by the correspondingly selected basis weight or by a multiple layer of the mat.

1. A method for manufacturing glass fiber reinforced plastics or carbon fiber reinforced plastics, comprising:
applying a resin-impregnated laminate to a rotating mold;
winding the laminate around by a first gas-permeable and liquid-permeable peel-ply; and
surrounding the peel ply by a mat as a layer for the absorption of excess resin consisting of thermally bonded plastic fibers, with at least one side of the mat having a solidified surface with a smaller pore size compared to the remaining pore size of the mat so that the solidified surface with the smaller pore size of the mat is arranged adjacent to the first peel-ply.

2. The method according to claim 1, wherein the mat has a basis weight between 50 g/m² up to 1000 g/m².

3. The method according to claim 1, wherein the mat has a layer thickness of from 0.3 mm to 10 mm.

4. The method according to claim 1, wherein the mat consists of at least one of polypropylene fibers, polyester fibers, polyamide fibers, and fibers of copolymers of the aforesaid materials.

5. A method for the manufacture of glass fiber reinforced plastics or of carbon reinforced plastics, comprising:
applying a resin-impregnated laminate to a mold;
surrounding the laminate by a liquid-permeable and gas-permeable peel-ply;
applying a mat as a layer for absorption of excess resin expelled during the manufacturing process consisting of thermally bonded plastic fibers, with at least one side of the mat having a solidified surface with a smaller pore size compared to the remaining pore size of the mat, such that the side of the mat with the solidified surface and the smaller pore sizes is arranged adjacent to the peel-ply; and
surrounding the mat by a vacuum-tight foil, with suction openings being provided in the latter via which a vacuum can be applied.

6. The method according to claim 5, wherein the mat has a basis weight between 50 g/m² up to 1000 g/m².

7. The method according to claim 5, wherein the mat has a layer thickness of from 0.3 mm to 10 mm.

8. The method according to claim 5, wherein the mat consists of at least one of polypropylene fibers, polyester fibers, polyamide fibers, and fibers of copolymers of the aforesaid materials.
